(19) United States
(12) Patent Application Publication
(10) Pub. No.: US 2002/0083602 A1
(43) Pub. Date: Jul. 4, 2002

(54) Fiber optic pin sights for bow

(76) Inventor: Scott O. Slates, Wentzville, MO (US)

Correspondence Address: Paul M. Denk, 763 South New Ballas Road, St. Louis, MO, 63141, US

(21) Appl. No.: 09/752,368

(22) Filed: Jan. 2, 2001

(51) Int. Cl. F41G 1/467; G02B 6/00

(52) U.S. Cl. 33/265; 385/147; 124/87

(57) ABSTRACT

This invention is a pin sight for a bow. The pin sight utilizes fiber optic cables for the pins. The fiber optic cables are partially exposed to ambient light. The pin sight includes an artificial light source which an archer may use to illuminate the pins when ambient light is insufficient. The light source utilizes an angled surface to direct light across the user's vision while the fiber optic cables turn the light and direct the light towards the user. The light source provides generally equal illumination to all pins regardless of position of the pins relative to the light source. The fiber optic cables are held in place by at least one mounting tube without compressive forces. The cables are supported by a pin blade and rest along a channel in the edge of the pin blade. The pins are formed integrally with the pin blades, at least a portion of the pins blades being adjoined to the pin by a step structure allowing the pin blade to be offset from the base of the pin. This offset position allows the pin blades and associated fiber optic cables to abut a neighboring pin blade and its associated fiber optic cable.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

This invention relates to a pin sight for bows, and in particular to fiber optic pin sights.

When bows are used for hunting or other target shooting, often pin sights are used. The pin of a pin sight is specifically calibrated for a particular distance by compensating for the necessary trajectory.

Pin sights are finely calibrated, and the use of multiple pins requires that each pin be precisely mounted regardless of its proximity to another pin. It is desirable to make each pin mount unobtrusive to each other pin mount. For that, when using fiber optics, which are fragile, the pin mount must also provide rigidity. The pin mount for a fiber optic cable must be rigid to protect not only the cable itself, but also to maintain the precise calibration of the pin.

Obviously, fiber optic cables are dependent upon their optical properties for the transmission of light. Transmission is optimized by the cable being free of physical distortions which would alter or aberrate the optical properties. Accordingly, fiber optic cables mounted as to apply no compression and maintain smooth contours are ideal.

In using a fiber optic pin sight, the fiber optic cables are more beneficial to the user when illuminated. Some fiber optic pin sights rely on ambient light while others contain a built-in a light source for illumination. The ambient illumination is dependent upon the surface collection area of the cable, while the artificial illumination is dependent upon a light source's ability to transmit light into the fiber optic cable.

### SUMMARY OF THE INVENTION

In accordance with the invention, generally stated, a fiber optic pin sight that is mountable to a bow is disclosed. The sight includes a mounting plate which is securable to a bow, a plurality of pin assemblies, an artificial light source secured to the mounting plate, a sight guard fastened to the mounting plate, and a horizontal, liquid-filled level mounted on the sight guard. The mounting plate has two bores, each of which allows a screw to pass through and fasten the sight guard and artificial light source assembly to the mounting plate. The mounting plate also has a flanged central vertical slot into which the pin assemblies are fitted. Each pin assembly has a screw and a base with a rectangular end. The pin base is sized to be fitted closely within the slot of the mounting plate and secured in place on the mounting plate by a screw. Each of these screws may be loosened or tightened manually. The pin bases are formed integral with a step, a pin blade, and two securing tubes. The pin assemblies have a fiber optic cable that makes a 90° turn and is secured at each end by a securing tube. The pin blade supports the fiber optic cables and has a thickness slightly greater than the fiber optic cables and a shape that forms the contour of the fiber optic cables. The step of each pin assembly is formed as to allow the overlapping of support structure so the fiber optic cables may be positioned closely together.

The fiber optic cables are protected by the pin blades, as well as by the sight guard. The sight guard is U-shaped and, with the mounting plate forming one side, forms a surrounded space within which the fiber optic cables are otherwise exposed. This allows the user to view targets through the surrounded space and prevents trees, brush or other objects that may come into contact with the fiber optic pin sight from damaging the cables. In addition, the sight guard, on its lower arm and within the surrounded space, has a cradle within which a generally horizontally oriented, liquid-filled level is mounted.

The artificial light source assembly includes a two-piece housing, a switch, a battery, a lightbulb, and a terminal contact. The housing has a body and a cover. The body is fastened to the mounting plate by upper and lower mount notches. The cover is secured to the body, for example, by three screws. One end of the switch protrudes from a slot in the side of the housing, and the rest of the switch is inside of the housing. The center of the switch has a notch forming a flange, and the switch may slide relative to the housing as to increase or decrease the amount of the switch protruding from the housing. The battery, lightbulb, and terminal contact are also each secured within the housing. The negative node of the battery is in contact with the terminal contact. The terminal contact is generally a flat piece of metal with one end in contact with the battery. This end is turned at slightly greater than a 90° angle as to apply spring pressure to the battery. The positive node of the battery is in contact with the switch and the spring pressure from the terminal contact keeps the battery touching both the terminal contact and the switch. The other end of the terminal contact is in electrical contact with the metal portion of the lightbulb's socket. When moved to its innermost position, the switch makes contact with the terminal end of the lightbulb and thus completes the circuit and illuminates the lightbulb. At the bulb portion of the lightbulb, the body of the housing has a beveled surface. The cover fits against this beveled surface while leaving a channel for the light to be emitted from the housing. The portion of the cover in contact with the beveled surface of the body is angled from the left to the right of the path of the artificial light and is covered with, in the present embodiment, a white reflective sticker. Thus, as the light shines on the sticker, the reflective surface of the cover's beveled surface directs the light uniformly across the faces of the fiber optic cables, regardless of the positions of the pins along the slot of the mounting plate.

### BRIEF DESCRIPTION OF THE DRAWINGS

FIG. 1 is a perspective view of a pin sight of the present invention as assembled;

FIG. 2 is an exploded view of the pin sight, in perspective;

FIG. 3 is a perspective view of the mounting plate;

FIG. 4 is a front elevational view of the pin sight;

FIG. 5 is a rear elevational view of the pin sight;

FIG. 6 is a top plan view of the pin sight;

FIG. 7 is a side elevational view of the pin sight;

FIG. 8 is a view similar to FIG. 4 but with a cover removed to show the battery and light bulb of the artificial light source assembly of the pin sight;

FIG. 9 is a side elevational view of the pin sight taken along line 9-9 of FIG. 4 with the lightbulb of the artificial light source assembly shown in phantom;

FIG. 10 is a rear elevational view of the pin sight taken along the line 10-10 of FIG. 6 with the body of the artificial light source assembly partially removed to show the lightbulb and reflective surface;

FIG. 11 is a cross-sectional view of the pin sight taken along line 11-11 of FIG. 5;

FIG. 12 is a perspective view of an uppermost pin of the pin sight assembly;

FIG. 13 is a perspective view of an upper-intermediate pin of the pin sight assembly;

FIG. 14 is a perspective view of a central pin of the pin sight assembly;

FIG. 15 is a perspective view of a lower-intermediate pin of the pin sight assembly;

FIG. 16 is a perspective view of a lowermost pin of the pin sight assembly; and

FIG. 17 is a cross-sectional view of a pin of the pin sight assembly taken along line 17-17 of FIG. 14.

### DESCRIPTION OF THE PREFERRED EMBODIMENT

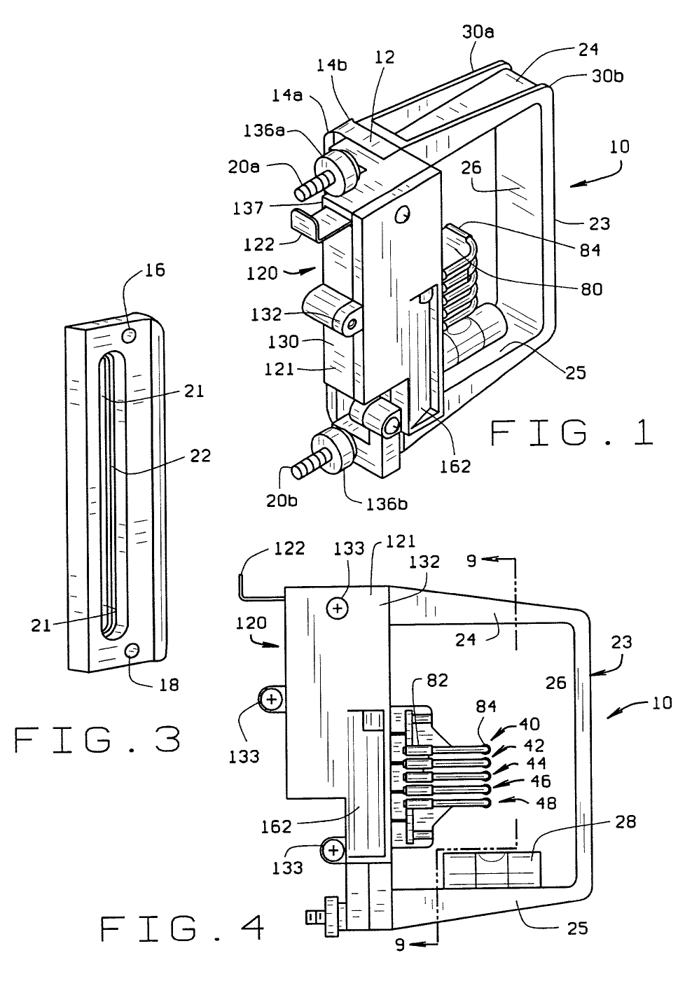

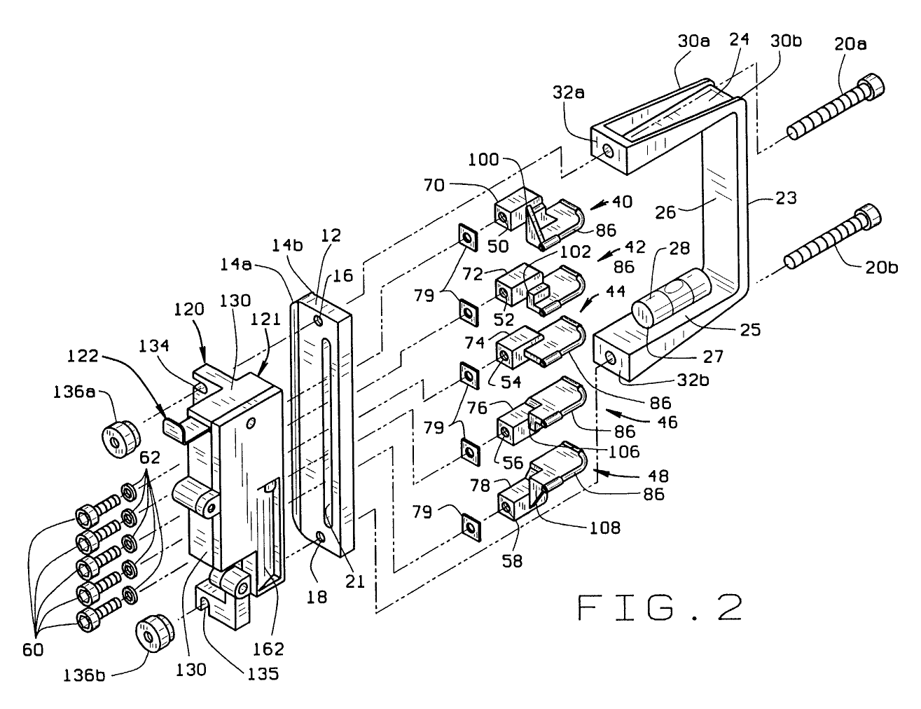

Referring initially to FIG. 1, a fiber optic pin sight 10 of the present invention is shown as assembled for mounting to an archery bow. FIG. 2 shows the pin sight in greater detail. The pin sight 10 includes a mounting plate 12 that can be secured to the bow in any conventional manner. As depicted, though not part of the claimed invention, there are mounting flanges 14a and 14b on the mounting plate (FIG. 11). The mounting plate 12 has an upper assembly bore 16 and a lower assembly bore 18, each of which is internally threaded for an upper assembly screw 20a and a lower assembly screw 20b, respectively. Referring now to FIG. 3, the mounting plate also has a vertical pin mount slot 21 with an internal shoulder or lip 22 flush with one side of the mounting plate 12. The upper and lower ends of both the shoulder and the slot are semi-circular with a diameter equal to that of the slot generally.

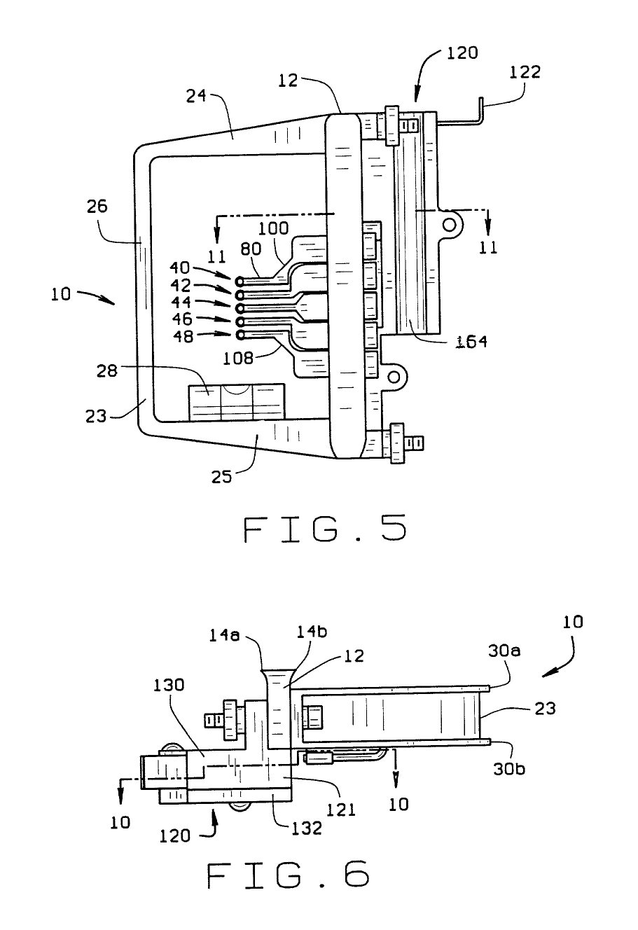

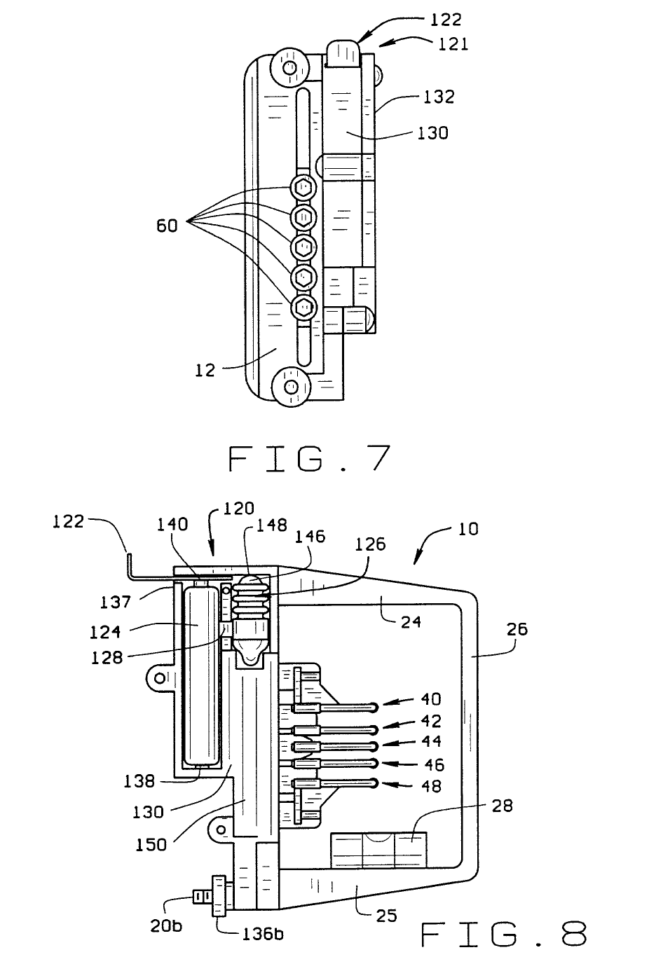

A sight guard 23 extends from one side of the mounting plate 12, as seen in FIG. 2. The sight guard 23 is generally U-shaped with an upper arm 24, a lower arm 25, and a bridge 26 extending between the arms. The lower arm 25 is formed integral with a cradle 27 which mounts a conventional, liquid-filled level 28 in a generally horizontal orientation. The bridge 26 is of uniform dimension and has uniformly raised outer edges 30a and 30b (FIG. 6). The raised outer edges 30a and 30b continue on the upper and lower arms, 24 and 25, and increase in height from the bridge 26 to the free ends of the arms 24 and 25. The raised outer edges 30a and 30b are joined at the free ends of the upper and lower arms 24 and 25 by an upper mounting face 32a and lower mounting face 32b. Each mounting face contains a bore through which the assembly screws 20a and 20b pass to secure the sight guard 23 to the mounting plate 12.

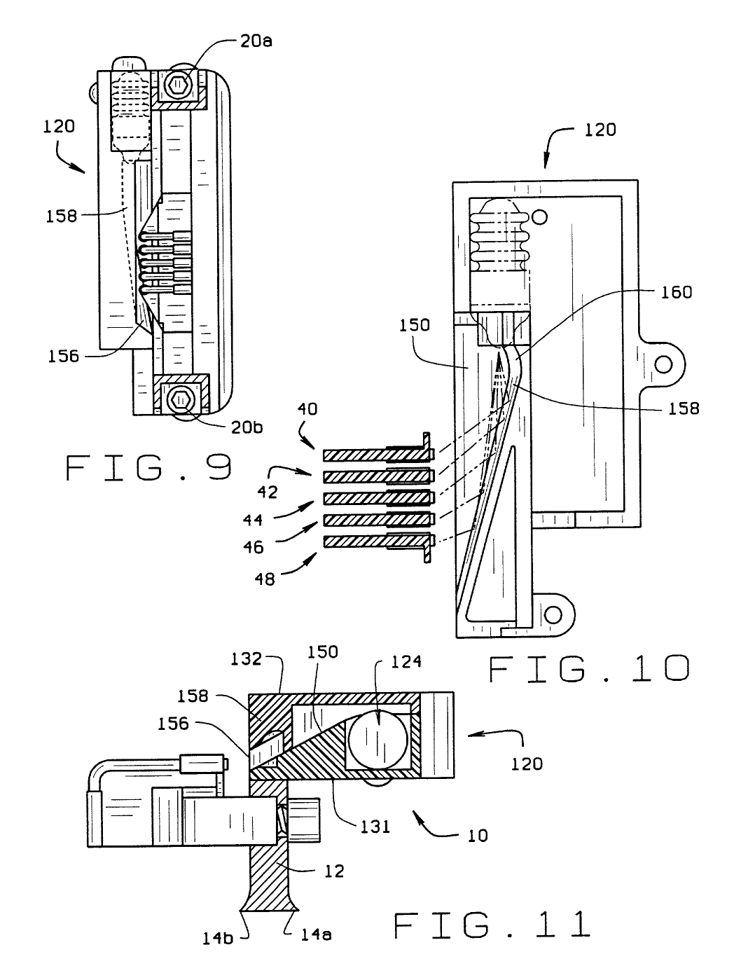

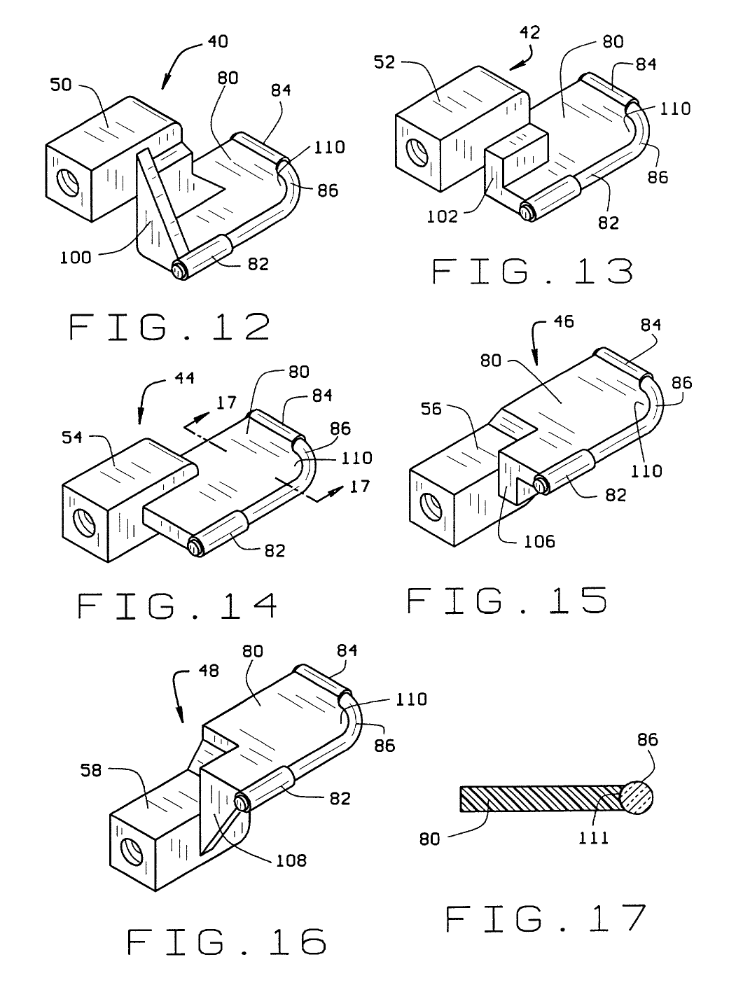

As can be seen in FIG. 2, the pin sight includes a plurality of pins. In the present embodiment, there is an uppermost pin 40, an upper-intermediate pin 42, a central pin 44, a lower-intermediate pin 46, and a lowermost pin 48, referred collectively herein as the pins and depicted in FIGS. 12-16, respectively. Pins 40 and 48 are mirror images of each other, as can be seen in FIGS. 12 and 16. Pins 42 and 46 are mirror images of each other, as can be seen in FIGS. 13 and 14. As FIGS. 12-16 display, each pin 40, 42, 44, 46, and 48 includes a generally rectangular base 50, 52, 54, 56, and 58 of generally square cross-section with an internally threaded bore. The pin bases are sized to slide within the mounting plate slot 21. Each pin is held in place by a pin mount screw 60 (FIG. 2) which passes through the mounting plate slot 21 and is threaded into the pin base bores. The head of the screws 60 have a surface and shape to allow for manual tightening or loosening of the pin mount screw. A circular washer 62 is positioned between the screw head and the face of the mounting plate 12. The back end 70, 72, 74, 76, and 78 of each pin base is seated within the slot 21 of the mounting plate 12, and against the shoulder 22 with square washers 79 between the pin base and the shoulder 22 (see FIGS. 2, 12-16).

As can be seen in FIGS. 12-16, the pins 40, 42, 44, 46 and 48 each include a pin blade 80 extending from a side of its respective base. The pin blade 80 is mounted horizontally at the horizontal center of the base 54. Each pin blade has a smoothly rounded corner 110. An initial cable tube 82 and a terminal cable tube 84 are at the ends of the edge of the blade 80. The terminal cable tube 84 begins at the back point of the pin blade and extends a short distance forward. The initial cable tube 82 begins at the front edge of the pin blade 80 and extends a short distance along the edge of the pin blade 80. The right edge and front edge, which form a continuous line due to the rounded corner 110 define a shallow channel 111 in which the fiber optic cable 86 is seated (FIG. 17). Each pin has a fiber optic cable 86. The pins 40, 42, 46, 48 also include a step 100, 102, 106, and 108 formed integrally with the pin base.

The steps 100, 102, 106 and 108 are extensions which offset each pin blade from its associated base and allow the pin blades to be fastened closer to a neighboring pin blade 80 (as depicted in FIG. 4). The central pin 44 does not include a step. The steps also provide a position offset from the base of a neighboring pin to allow one step to physically overlap the step of a neighboring pin. The steps also support and provide strength and rigidity to the pin blades 80. That is, the pin blades 80 extend from the steps.

The cable 86 is mounted to the pin blade 80 by inserting the cable 86 through the terminal cable tube 84 and the initial cable tube 82 and threading the cable along the channel. Mounting the cable 86 in this manner assures firm positioning of the cable 86 while not exerting compressive forces upon the cable 86 which otherwise would serve to distort the optical properties of the fiber optic material. The cable 86 may be properly sized before installation. Alternatively, the cable 86 may be inserted and, once properly seated, cut. As a second alternative, the cable 86 may be cut with a heat cutter, thereby causing the ends of the cables 86 to enlarge slightly and thusly preventing the cable 86 from slipping out of either the terminal cable tube 84 or initial cable tube 82. The majority of the cable 86 is exposed to ambient light, allowing the cable 86 to collect this light and transmit it to the user. The terminal cable tube 84 is positioned as to allow the cable 86 to direct the light towards the user's eye. The initial cable tube 82 is positioned to allow the cable 86 to receive and transmit light from an artificial light source assembly 120.

As can be seen in FIG. 8, the artificial light source assembly 120 includes a two-piece housing 121, a switch 122, a battery 124, a lightbulb 126, and a terminal contact 128. The housing 121 is comprised of a body 130 and a cover 132 (see FIG. 1; FIG. 3 shows the cover on, FIG. 8 shows the cover removed). The cover 132 is secured to the body 130 by three screws 133 (see FIG. 4). The cover 132 could of course be secured to the body 130 by any other conventional means which will allow for removal of the cover 132 from the body 130. The artificial light source assembly 120 has an upper mount notch 134 and a lower mount notch 135, each aligning with the threaded bores 16 and 18 in the mounting plate 12 such that the upper assembly screw 20a and lower assembly screw 20b are received in the notches 134 and 135, respectively (FIG. 2). The artificial light source assembly 120 is secured to the mounting plate 12 by internally threaded nuts 136a and 136b which fasten on the terminal ends of the assembly screws 20a and 20b. As seen in FIG. 2, the upper mount notch 134 has a horizontal orientation, and the lower mount notch 135 has a vertical orientation.

The switch 122 is slidingly received in the housing 121. One end of the switch 122 protrudes from a slot 137 in the side of the housing 121, and the rest of the switch 122 is inside of the housing 121. The center of the switch 122 has a notch forming a flange (not shown), and the switch 122 may be slid by the user to increase or decrease the amount of the switch protruding from the housing 121. As described below, the sliding of the switch opens and closes a circuit which allows an archer to turn the bulb 126 on and off when desired. The battery 124, lightbulb 126, and terminal contact 128 are also each secured within the housing 121. The negative node 138 of the battery 124 is in contact with the terminal contact 128. The terminal contact 128 is generally a flat piece of metal with the end in contact with the battery 124 turned at slightly greater than a 90° angle so as to apply spring pressure to the battery 124. The positive node 140 of the battery 124 is in contact with the switch 122, and the spring pressure from the terminal contact 128 keeps the battery 124 in contact with both the terminal contact 128 and the switch 122. The other end of the terminal contact 128 in contact and electrical communication with the threaded portion 146 of the base of the lightbulb 126. When moved to its innermost position, the switch 122 makes contact with the terminal end 148 of the lightbulb 126, thus completing the circuit and causing the lightbulb 126 to illuminate.

At the head or bulb portion of the lightbulb 126, the housing body 130 has a beveled surface 150 (FIG. 11). The cover 132 fits against this beveled surface 150 while leaving a channel 156 through which light is emitted from the housing 121 (see FIGS. 9, 11). The housing cover 132 includes an angled surface 158 that is in contact with the beveled surface 150 of the body 130 and which is angled across the path of the artificial light (seen as a dashed line in FIG. 9 and, in reverse view, in FIG. 10). The angled surface 158 is biased from both the ordinate and abscissa of the user's perspective.

As seen in FIG. 10, the biases of the cover angled surface 158 result in light shining, generally, across the user's plane of vision, as well as with a slight angle towards the rear so as to create a band of light from the channel 156 and to provide the greatest illumination upon the initial face end of the fiber optic cable 86. In the present embodiment, the angled portion 158 is covered with a white reflective sticker 160 (see FIG. 10). Thus, as the light shines on the sticker 160, the reflective surface of the angled surface 158 of the cover 132 directs the light uniformly across the faces of the fiber optic cables 86 regardless of the position a pin is fastened along the slot 21 of the mounting plate 12.

To minimize size and materials of the artificial light source assembly 120, there are a number of external features. The front of the cover 132 has a beveled inset 162 that follows the angled surface 158, which in turn follows the beveled surface 150 (see FIG. 4). The back of the body 130 has a similar beveled inset (not shown) which is the structure resulting from the beveled surface 150. The back of the body 130 also has a vertically oriented protrusion 164, of partial cylindrical shape, which conforms to the positioning of the battery 124 within the housing 121, as seen in FIG. 5.

From the foregoing, it can be seen that I have provided a fiber optic pin sight having a lighting assembly which uniformly lights the pins regardless of the position of the pins on the sight. Additionally, the switch allows an archer to activate the lighting assembly when desired.

As various changes could be made in the construction without departing from the scope of the invention it is intended that all matter contained in the above description or shown in the accompanying drawings shall be interpreted as illustrative and not in a limiting sense. For example, the pin bases could be secured in the mounting plate by means other than the screw 60. The switch 122 can be replaced with other types of switches, such as a toggle switch. A single long mounting tube can be used in place of the mounting tubes 82 and 84. The pin blade and lighting assembly can be formed so that the fiber optic cables turn an angle of other than 90°, while still directing the light ot he archer. These examples are merely illustrative.

1. A fiber optic pin sight, mountable to an archery bow, the pin sight including:
a plurality of pins, each including a fiber optic cable, and an artificial light source which illuminates the fiber optic cables;
the light source directing light across the plane of a user's vision;
the fiber optic cables of the fiber optic pins making a turn to direct the light towards the user's vision.

2. The fiber optic pin sight of claim 1 whereby the artificial light source provides generally equal illumination to each fiber optic cable regardless of the position of each pin relative to the light source.

3. The fiber optic pin sight of claim 2 wherein the artificial light source includes a housing and a source of illumination;
said light source housing containing an angled surface which directs the light onto initial ends of the cables.

4. The fiber optic pin sight of claim 3 wherein the angled surface has reflective coating mounted thereon.

5. A fiber optic pin sight, the pin sight apparatus being mountable to an archery bow, the pin sight including:
a mounting plate and a plurality of pins each mounted to said mounting plate; each of said pins having a base, a pin blade extending from the base and a fiber optic cable extending along the edge of the blade;
each of said pin bases providing a firm and precise mount for said pin blade, whereby the position of said fiber optic cable may be precisely mounted so that the cable itself is sufficiently rigid as to maintain the cable in a desired position.

6. The fiber optic pin sight of claim 5 wherein the position of each pin on the mounting plate can be independently set.

7. The fiber optic pin sight of claim 5 wherein the base structure of at least one pin includes a step from which the pin blade extends to offset the pin blade from the base so that the pin sight may be configured so the pin blade and the respective fiber optic cable abuts a neighboring pin blade and respective fiber optic cable.

8. The fiber optic pin sight of claim 5 wherein said fiber optic cable is secured at each end without the use of compressive forces.

9. The fiber optic pin sight of claim 8 wherein the initial end of the fiber optic cable is turned approximately 90° from the direction of the terminal end of the fiber optic cable.

10. The fiber optic pin sight of claim 9 wherein each pin includes a mounting tube on the pin blades, the fiber optic cable being received in the by mounting tube.

11. The fiber optic pin sight of claim 10 wherein the pin blade includes a channel which receives a fiber optic cable, said channel having less than a cross-section less than a full circle.

12. The fiber optic pin sight of claim 11 wherein at least a portion of the fiber optic cable is exposed to and transmits ambient light.

13. The fiber optic pin sight apparatus of claim 10 wherein the fiber optic cable extends slightly beyond the mounting tube and are headed over to remain secure in their position.
